(19) United States
(12) Patent Application Publication
(10) Pub. No.: US 2021/0064648 A1
(43) Pub. Date: Mar. 4, 2021

(54) SYSTEM FOR AUTOMATED DYNAMIC GUIDANCE FOR DIY PROJECTS

(71) Applicant: KONINKLIJKE PHILIPS N.V., Eindhoven (NL)

(72) Inventors: Oladimeji Feyisetan Farri, Yorktown Heights, NY (US); Vivek Varma Datla, Ashland, MA (US); Yuan Ling, Somerville, MA (US); Sheikh Sadid Al Hasan, Cambridge, MA (US); Ashequl Qadir, Melrose, MA (US); Kathy Mi Young Lee, Westford, MA (US); Junyi Liu, Windham, NH (US); Payaal Patel, Reading, MA (US)

(21) Appl. No.: 16/998,128

(22) Filed: Aug. 20, 2020

Related U.S. Application Data
(60) Provisional application No. 62/891,787, filed on Aug. 26, 2019.

(51) Int. Cl. G06F 16/435; G06F 16/438; G06F 16/44; H04N 21/84; H04N 21/8543; H04N 21/858; H04N 21/4545

(52) U.S. Cl. CPC G06F 16/435; G06F 16/438; G06F 16/44; H04N 21/4545; H04N 21/8543; H04N 21/858; H04N 21/84

(57) ABSTRACT

A method for presenting do-it-yourself (DIY) videos to a user related to a user task by a DIY video system, including: receiving a user query including a first image file and a text question from a user regarding the current state of the user task; extracting entities from the first image file to create entity data; extracting question information from the text question; extracting from a DIY video index a video segment related to the user task based upon the entity data and the question information; and presenting the extracted video segment to the user.

### CROSS-REFERENCE TO RELATED APPLICATION

This application claims the benefit of and priority to U.S. Provisional Application Ser. No. 62/891,787, filed Aug. 26, 2019. These applications are hereby incorporated by reference herein.

### TECHNICAL FIELD

Various exemplary embodiments disclosed herein relate generally to a system for automated dynamic guidance for do it yourself (DIY) projects.

### BACKGROUND

The culture of Do-it-yourself (DIY) has become mainstream for consumers who need to resolve issues with products and equipment. Many manufacturers and product experts created publicly accessible resources (e.g., YouTube videos) related to unravelling and fixing product-related issues. Although some of these videos are concise and address a specific product malfunction, a significant proportion of them are comprehensive and complex, covering a wide range of potential malfunctions and how they can be fixed. If a customer refers to the complex videos to understand how to fix an issue, they typically have to review various frames/segments of the videos to extract the knowledge they need. They may also experience a lot of disruption in their workflow as they frequently have to check and re-check if they are in sync with the step-by-step instruction from the video.

### SUMMARY

A summary of various exemplary embodiments is presented below. Some simplifications and omissions may be made in the following summary, which is intended to highlight and introduce some aspects of the various exemplary embodiments, but not to limit the scope of the invention. Detailed descriptions of an exemplary embodiment adequate to allow those of ordinary skill in the art to make and use the inventive concepts will follow in later sections.

Various embodiments relate to a method for presenting do-it-yourself (DIY) videos to a user related to a user task by a DIY video system, including: receiving a user query including a first image file and a text question from a user regarding the current state of the user task; extracting entities from the first image file to create entity data; extracting question information from the text question; extracting from a DIY video index a video segment related to the user task based upon the entity data and the question information; and presenting the extracted video segment to the user.

Various embodiments are described, further including receiving from the user a second image file corresponding to the state of the user task at completion of the user task; and comparing the second image file to data indicating an ideal state at the completion of the user task.

Various embodiments are described, further including indicating to the user that the user task is complete based upon the comparison of the second image file to data indicating an ideal state.

Various embodiments are described, further including: indicating to the user that the user task is not complete based upon the comparison of the second image file to data indicating an ideal state; and providing to the user feedback as to the differences between the current state of the user task and the ideal state.

Various embodiments are described, wherein providing to the user feedback includes displaying both the second image and an image of the ideal state to the user.

Various embodiments are described, wherein the extracting from a DIY video index a video segment related to the user task based upon the entity data and the question information includes extracting a plurality of video segments, further comprising selecting a portion of the plurality of video segments to present to the user.

Various embodiments are described, wherein the user task includes a plurality of sub-tasks and wherein the selected portion of the plurality of video segments corresponds to the sub-tasks.

Various embodiments are described, wherein portions of the selected video segments are identified and combined together to present a contiguous video to the user.

Various embodiments are described, wherein user task includes a plurality of sub-tasks,

the user query indicates that the current state of the user task corresponds to a sub-task, and presenting the extracted video segment to the user includes identifying a start point in the extracted video segment corresponding to the sub-task indicated by the current state of the user task.

Various embodiments are described, wherein entity data includes identified objects identified in the first image file and the relative position of the identified objects to on another.

Various embodiments are described, further including: determining a tool or a part required to carry out the user task based upon the extracted video segment; and providing to the user information wherein to acquire the tool or part and the cost of the tool or part.

Various embodiments are described, further including: receiving from the user information regarding an alternative source for acquiring the tool or part; and adding the information regarding an alternative source for the tool or part to the DIY video index after the information has been approved by an expert.

Further various embodiments relate to a method for indexing do-it-yourself (DIY) videos that portray a user task in an index by a DIY video system, including: receiving a DIY video; applying a machine learning model to the received video to extract visual entity data from each frame in the DIY video and storing the visual entity data in the index; extracting audio from the received video;

transcribing the extracted audio; identifying user task segments in the transcribed audio; determining temporal user task boundaries in the received video segment based upon the identified user task segments; and storing user task segment data and the temporal user task boundaries in the index.

Various embodiments are described, further including: receiving manuals related to the received DIY video; extracting meta data from the manual related to the user task; and storing the extracted manual meta data in the index.

Various embodiments are described, wherein the extracted meta data includes images related to the user task and text describing the steps of the user task.

Various embodiments are described, wherein the visual entity data includes identifying objects in the frame and the relative position of the objects to one another in the frame.

Various embodiments are described, wherein the visual entity data includes text found in the frame that is converted to a machine readable representation of the text.

Various embodiments are described, further including extracting closed caption information from the received DIY video and storing the closed caption information in the index.

Various embodiments are described, wherein the machine learning model is trained using data from a manual related to the task portrayed in the DIY video.

Various embodiments are described, wherein the data stored in the index for the received video segment comprises a DIY video signature.

Various embodiments are described, further including identifying sentence boundaries in the transcribed audio and storing sentence text from the transcribed audio in the index.

Various embodiments are described, further including extracting text meta data associated with the received DIY video and storing the extracted text meta data in the index.

### BRIEF DESCRIPTION OF THE DRAWINGS

In order to better understand various exemplary embodiments, reference is made to the accompanying drawings, wherein:

FIG. 1 illustrates a flow diagram of DIY video indexing system;

FIG. 2 illustrates the caching the meta-data related to the places where component/tool may be purchased;

FIG. 3 illustrates the operation of the DIY video system;

FIG. 4 illustrates the automatic identification of task completion by the DIY video system; and

FIG. 5 illustrates an exemplary hardware diagram for implementing the DIY video system.

To facilitate understanding, identical reference numerals have been used to designate elements having substantially the same or similar structure and/or substantially the same or similar function.

### DETAILED DESCRIPTION

The description and drawings illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be for pedagogical purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments.

The culture of Do-it-yourself (DIY) has become mainstream for consumers who need to resolve issues with products and equipment. Many manufacturers and product experts created publicly accessible resources (e.g., YouTube videos) related to unravelling and fixing product-related issues. Although some of these videos are concise and address a specific product malfunction, a significant proportion of them are comprehensive and complex, covering a wide range of potential malfunctions and how they can be fixed. If a customer refers to the complex videos to understand how to fix an issue, they typically have to review various frames/segments of the videos to extract the knowledge they need. They may also experience a lot of disruption in their workflow as they frequently have to check and re-check if they are in sync with the step-by-step instruction from the video. Embodiments will be described herein that address the workflow disruption and difficult knowledge extraction by automatically retrieving the specific segment in a DIY video that matches the current stage the customer is on, in a dynamic manner that allows easy step-wise guidance to fix an issue.

Embodiments of a DIY video system may include various of the following elements.

The DIY video system may index videos using audio, text, and the description given for the videos describing tasks. Further, the DIY video system may automatically identify the beginning and end of tasks based on the description in the video. The DIY video system may also convert tasks into a sequence of sub-task operations and then construct a hierarchical view and relationships among the various sub-tasks. Next, the DIY video system may use image-segmentation on each frame and independently identifying the entities in the frame and associating them to the parts, components, and tools being used in carrying out the task. Further, the DIY video system may map the current video feed of the task to the stage in indexed videos based upon the internal state representation of the current task. The DIY system determines the local goal for the current operation and the trajectory to the main goal based on a user query. Further, the DIY system may search the documentation related to the task identified in the user query to associate the risks and mitigation strategies for the current tasks.

The DIY video system may also create automatic queries for identifying the cost of and the places where the tools identified in the videos are available and cache this information in the background to be available on-demand for the user. The DIY video system may also associate multiple videos describing/showing the same task to provide choices to the user. Next, the DIY video system may retrieve a plurality of video segments related to the query and stitch together multiple videos targeted to the query. The DIY video system may provide the following information to the user: analytics and requirements associated with the task; tools needed; risks identified for the task; presenting on-line shopping sites where they can purchase the items; and an end-to-end query driven DIY knowledge guide. Each of these elements will be described in further detail below.

The DIY video system leverages real-time image analysis, asynchronous video segmentation, and natural language processing (NLP) for video subtitles/captions. The DIY video system offers efficient and accurate extraction of knowledge in sync with various task stages while using a video feed (related to the current task being carried out) to resolve issues with products and equipment. Components of the DIY video system include a database of DIY videos of varying lengths with instructions on how to accomplish certain tasks. The videos are segmented using multi-instance segmentation techniques, e.g., Mask R-CNN. The captions/subtitles associated with each video may be extracted using the voice-over (and speech-to-text) or video (still) frame extraction and optical character recognition (OCR) software for those videos without voice-over. The captions/subtitles may be retrieved along with the corresponding time stamps such that a phrase/sentence may be mapped to the correct video segment within the database.

When a customer is performing a task in real-time (in the process of resolving an issue), they may capture the relevant components of the product in question with a smart phone. The captured image becomes the input for a faster regional convolutional neural network (faster R-CNN, but other types of models may be used as well) model that has been trained on the still frames and key-words/phrases from the database. Following classification of the image by the faster R-CNN model, a database look-up algorithm is used to retrieve the DIY video segment that corresponds to the classes (key-words/phrases) associated with the user query as determined by the faster R-CNN model. If there are multiple video segments related to the output classes, then associated time stamps and the structure of the task to be performed are used to show the segments in a logical sequence. The customer may then effectively use the temporally sequenced DIY video segments as context-aware guidance towards accomplishing the task related to the product of interest, and there would be a feedback mechanism to efficiently compare a smart phone-derived image at the completion of the task with the end-result of the relevant video segment (so the customer can tell if ‘they did the right things’). Also, using APIs/links to e-commerce sites with tools and replacement parts relevant to the task represented in the DIY video segment.

The DIY video system may be used to help with a wide variety of tasks. For example, if a user needs help with a consumer product, the user may take a picture or video of the product and input a query. For example, with an electric toothbrush, how do you change the head, or with an electric shaver, how do you replace the blades. In another example, if a user or repair technician needs repair a coffee maker, a picture or video of the coffee maker may be taken and a query made, for example, “how do I replace the heating element.” In such a situation the user may start with the coffee maker intact or with an external cover removed. In either case, the user takes a picture of the current state of the coffee maker. In the case where the cover has been removed, the DIY video system does not need to queue up a video segment showing how to remove the cover, but when the cover has not been removed this video would be included. The system may be used in other repair situations, for example a repairing a copier or other office equipment, home appliances, consumer electronics, home repairs, plumbing repairs, etc.

As the user is carrying out steps based upon the videos, they may take a picture or video and make a further inquiry if it is not clear what they should do next. Also, as the user completes a step or the whole task a picture may be taken to verify that they have properly completed the task. Also, as the user is carrying out the tasks, certain tools may be identified as necessary to carry out the task. If the user does not own the tool, the DIY system may suggest where the tool may be both and how much it costs. It may also facilitate ordering the missing tool.

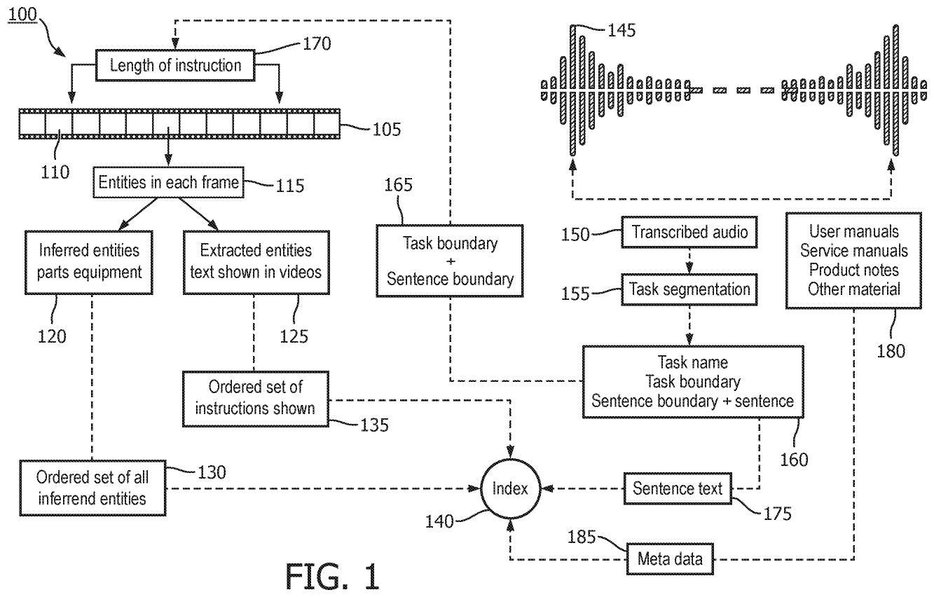

FIG. 1 illustrates a flow diagram of DIY video indexing system. The DIY indexing system 100 analyzes DIY videos and produces index entries that may then later be found in an index search. First each frame 110 of the DIY video 105 is analyzed to determine the entities found in each frame 115. This may be done using varies types of machine learning models including convolutional neural networks (CNN) or mask-R CNNs. Part of the training of this machine learning model may include the use of figures from an instruction, user, or service manual, product notes, or other product material 180, for example. Throughout this description these various materials may be simply referred to as manuals. These entities may include inferred entities that identify parts and equipment 120. These inferred entities may include information about the relative position to one another of the different entities found in the frame 110 of the DIY video. Also, instructions may refer to an item, such as “reset the alarm after changing the settings.” In this case the alarm may be inferred from the instructions. Other inferred information from the frame 110 may include identifying tools used in the from (e.g., screw drivers, pliers, wrenches, etc.) An ordered set of the inferred entities may then be created and stored in the index 140. Further, extracted entities such as text shown in the videos may be extracted from each frame 125. Next, an ordered set of instructions shown may be determined from the extracted entities and stored in the index 140. This may be accomplished using various machine learning models to determine the meaning of the text shown in the videos and then to extract a set of instructions from the text.

The DIY indexing system 100 also extracts audio 145 from the DIY videos. The audio may then be transcribed using various known methods and techniques 150. The text corresponding to the audio is then analyzed to identify task segments 155. Task segmentation 155 may be done using manuals 180 that identify the task shown in the video 110 by mapping extracted text to specific section(s) of the manual. Then each phrase in the extracted audio may be mapped to a particular step mentioned in the manual. This helps to better merge the meta data from the manuals with the task steps in the audio. The segmentation sought is as close to as possible to the standard procedure steps mentioned in the manuals. Also, such task segmentation 155 may be done using various known text processing methods with or without the manual data. Further, the task segments are then analyzed to extract a task name, task boundaries, sentence boundaries, and the sentences 160. The sentence text 175 may then be stored in the index 140. The task boundaries and sentence boundaries 165 are then used to determine the length of instruction 170 for the various tasks found in the DIY video 105.

The DIY indexing system also analyzes instruction, user, or service manuals, product notes, or other written/printed material related to the tasks that may be found in the DIY videos 105. This analysis produces meta data 185 that may be stored in the index 140. Such meta data may include pictures (that may be used to train the models that extract entities from the DIY video frames) and text that describes various tasks and the steps of that task. The signature of each frame becomes an atom in creating a temporal signature of specific tasks. The flexibility of searching for information in multiple mediums (video+image+text+meta_data) helps in avoiding false hits.

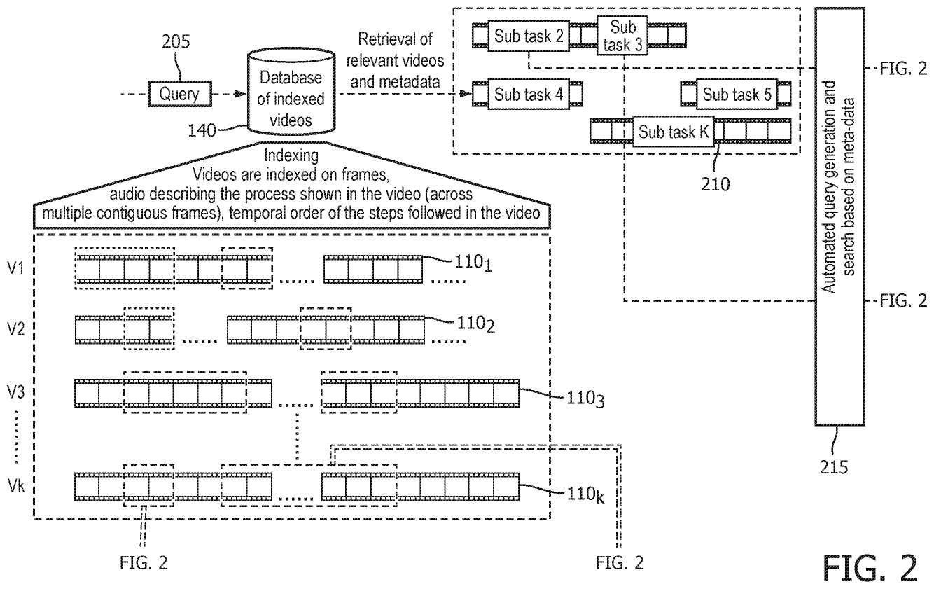

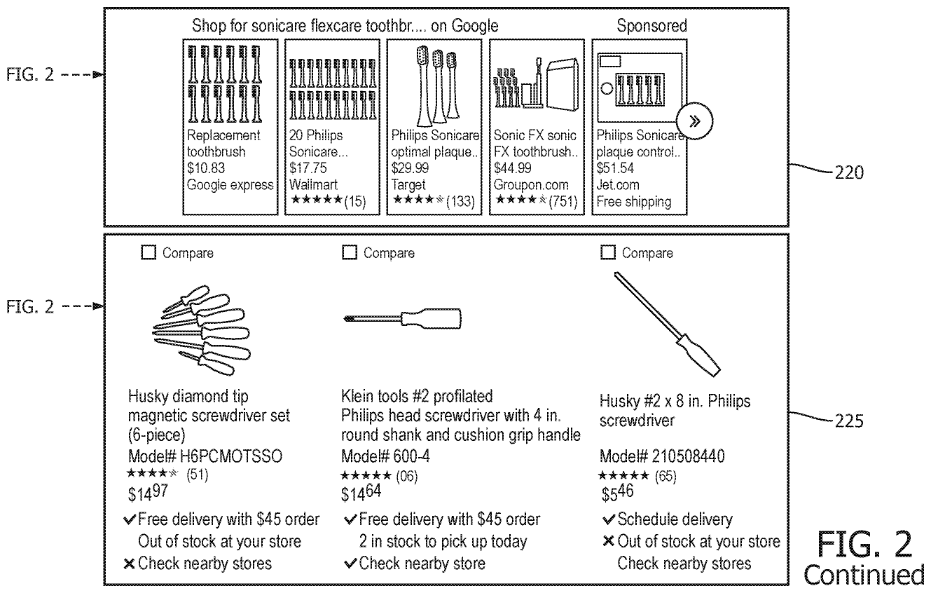

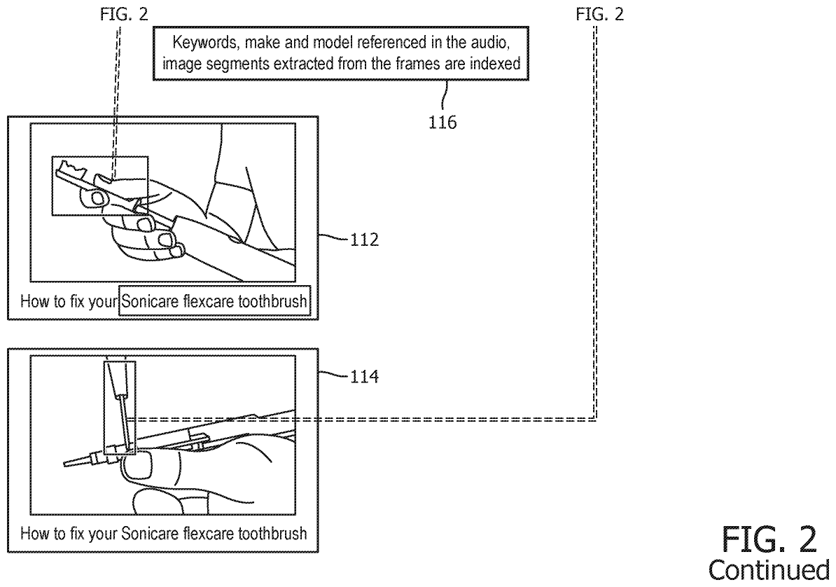

FIG. 2 illustrates the caching the meta-data related to the places where component/tool may be purchased. The DIY video system receives a query 205. The query 205 is compared to the various entries in the index 140. The index include data for various video segments 110₁ to 110ₖ. In this example, the query may be related to fixing a specific model of electric toothbrush. The make and model of the toothbrush may then be used to search for these key words 116 in the index 140. For example, a frame 112 may reference the specific model of electric toothbrush found in the query. Hence, this video segment is relevant to the user query 205. In another frame 114, mention is made about how to fix the electric toothbrush. Also, the frame 114 references the use of a screwdriver. As a result, the indexed information includes cached data relating to how to purchase the screwdriver if the user does not have one. Such information may include a source (i.e., a website) where the tool may be purchased and the price of the tool. Also, as a replaceable toothbrush head is described in the video frame, data regarding where and how to purchase replacement toothbrush heads may be included as well during indexing. In some cases, the tools shown in the videos may be unique or rare tools, and in such cases the information on how to acquire the tool would be especially helpful to the user.

The query of the index 140 produces a set of videos 210 related to the query 205. Various sub-tasks of the overall task may be found in different videos as shown. The DIY video system may then perform an automated query generation and search based upon meta-data of the set of videos 210 related to tools or parts identified in the set of videos 210. This information then may be used to present to the user the cached data related to the identified tool or part. For example, various options for purchasing replacement toothbrush heads 220 may be presented. Also, information related to purchasing a screwdriver (or another tool) 225 may be presented to the user. This allows the user to easily order the needed replacement toothbrush heads or tools. In another embodiment, the user may have the option to identify a better place to by the tool or part and the cache may store this information as a purchase option once the suggested option has been validated by an expert.

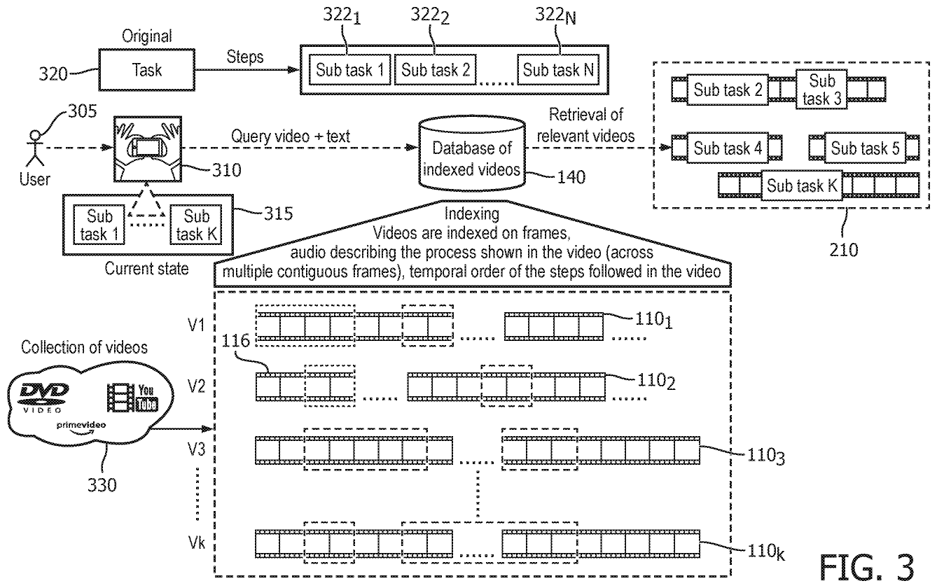

FIG. 3 illustrates the operation of the DIY video system. The user 305 takes a picture or video of the current task being performed as well as a question. For example, “how to I repair a specific model of an electric toothbrush.” The video is broken down and analyzed similar to the process used in indexing the videos described above. If only a picture of the current task is taken, it is analyzed like a single frame of the video as described above regarding the DIY indexing system. The task 320 that the user is undertaking may include a number of sub-tasks 322₁, 322₂, to 322_{N}. The DIY video system will attempt to determine the specific sub-tasks that need to be completed based upon the current state of the task. The query that includes information regarding the video and the text of the user's question will be used to identify a set of relevant videos 210. It is noted that the index contains various data for each of the videos 110₁, 110₂, to 110ₖ. This data is based upon indexing of a collection of DIY videos 330.

Based upon data extracted from the user photograph, a match of the sub-task signature across the database is obtained. This helps in identifying the stage of the task completion the user is in. The assumption is that the user is following standard instruction protocols. Each sub-task is identified with a begin-step and end-step. This helps in identifying which sub-task is the current sub-task for the user's current status. As the user carries out each sub-task, the user may provide feedback at each sub-task as to whether the selected video segment was useful or not. This information will be used to modify the index and also help in creation of dataset for learning the relationship between the video and usefulness with respect to the sub-task.

Further, a new instruction video may be automatically created by stitching together the sub-tasks in the same order as the original instruction video based on user preferences. This customization may also be done based on the tools the user has in his/her inventory.

If no match to a specific sub-task is found, then the whole video related to the query is shown.

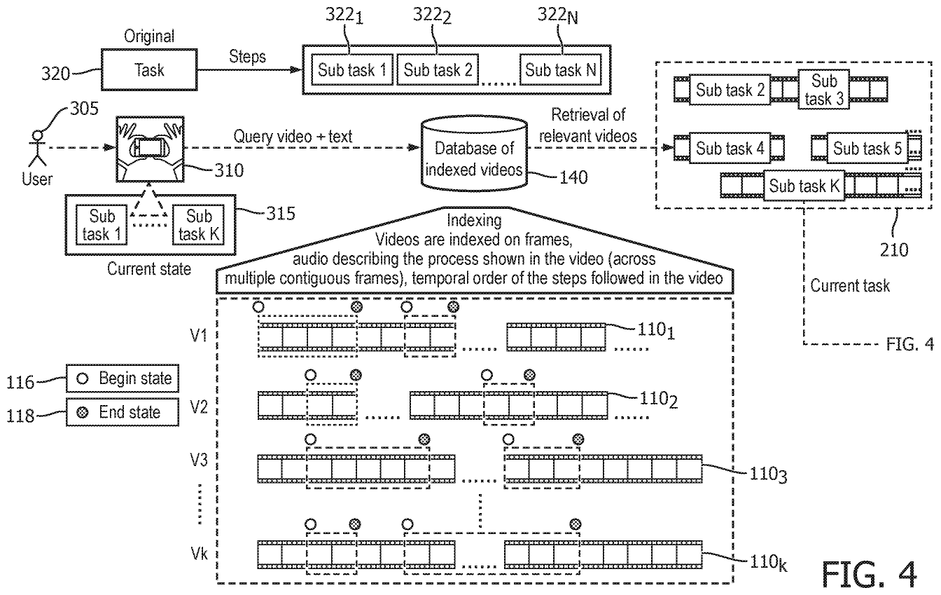

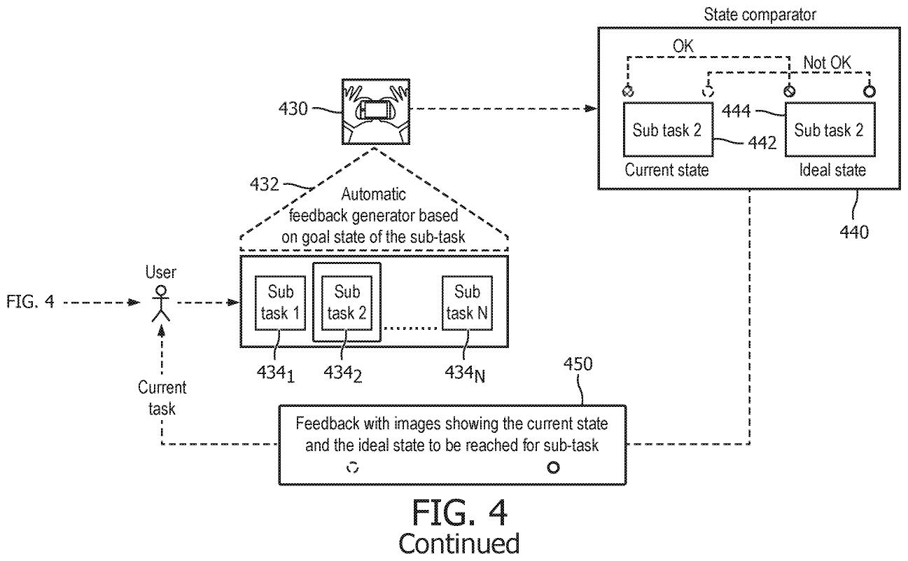

FIG. 4 illustrates the automatic identification of task completion by the DIY video system. Portions of FIG. 4 are identical to those of FIG. 3 and those portions do not need to be explained again here. Each sub-task may have a begin state 116 and end state 118. These begin and end states are shown for the various segments of the videos 110₁ to 110ₖ. The begin states may be used to identify the specific sub-task corresponding to the current state of the user. The end states may be used to help determine if the user properly completed the sub-task before moving on to the next sub-task or task. This is done when the user takes a picture or video 430 of the current state of the task when the user believes they have finished the current sub-task. This allows for automatic feedback 432 by the DIY video system regarding the completion of various sub-tasks 434₁, 434₂, to 434_{N}. A state comparator 440 compares the current state 442 as captured by the user with the ideal state 444 at the completion of the sub-task. This comparison may identify and compare the various items found in the frame. For example, if items are missing in the current state then the task may not be completed. Also, the spatial relationships and alignment of the items of the current state may be compared to those in the ideal state. The state comparator may generate a task completion score that indicates the level of success achieved in completing the sub-task. If this score is low, dynamic feedback may be provided to the user to go back and check the sub-task to determine what steps were missed or done incorrectly. This may include providing images of the current state and the ideal state side by side. Further, the state comparator may identify one or more items in the current state that do not align with the ideal state. This provides feedback to the user that may be utilized to properly complete the sub-task.

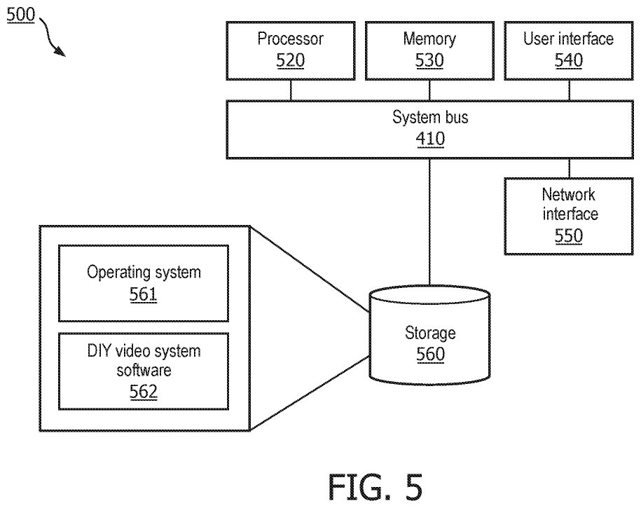

FIG. 5 illustrates an exemplary hardware diagram 500 for implementing the DIY video system. The exemplary hardware 500 may implement the whole DIY video system or separate instances of the exemplary hardware 500 may implement different portions of the DIY video system. As shown, the device 500 includes a processor 520, memory 530, user interface 540, network interface 550, and storage 560 interconnected via one or more system buses 510. It will be understood that FIG. 5 constitutes, in some respects, an abstraction and that the actual organization of the components of the device 500 may be more complex than illustrated.

The processor 520 may be any hardware device capable of executing instructions stored in memory 530 or storage 560 or otherwise processing data. As such, the processor may include a microprocessor, field programmable gate array (FPGA), application-specific integrated circuit (ASIC), or other similar devices.

The memory 530 may include various memories such as, for example L1, L2, or L3 cache or system memory. As such, the memory 530 may include static random-access memory (SRAM), dynamic RAM (DRAM), flash memory, read only memory (ROM), or other similar memory devices.

The user interface 540 may include one or more devices for enabling communication with a user. For example, the user interface 540 may include a display, a touch interface, a mouse, and/or a keyboard for receiving user commands. In some embodiments, the user interface 540 may include a command line interface or graphical user interface that may be presented to a remote terminal via the network interface 550.

The network interface 550 may include one or more devices for enabling communication with other hardware devices. For example, the network interface 550 may include a network interface card (NIC) configured to communicate according to the Ethernet protocol or other communications protocols, including wireless protocols. Additionally, the network interface 550 may implement a TCP/IP stack for communication according to the TCP/IP protocols. Various alternative or additional hardware or configurations for the network interface 550 will be apparent.

The storage 560 may include one or more machine-readable storage media such as read-only memory (ROM), random-access memory (RAM), magnetic disk storage media, optical storage media, flash-memory devices, or similar storage media. In various embodiments, the storage 560 may store instructions for execution by the processor 520 or data upon with the processor 520 may operate. For example, the storage 560 may store a base operating system 561 for controlling various basic operations of the hardware 500. The storage 562 may include the software instructions used to implement the DIY video system or portions thereof.

It will be apparent that various information described as stored in the storage 560 may be additionally or alternatively stored in the memory 530. In this respect, the memory 530 may also be considered to constitute a “storage device” and the storage 560 may be considered a “memory.” Various other arrangements will be apparent. Further, the memory 530 and storage 560 may both be considered to be “non-transitory machine-readable media.” As used herein, the term “non-transitory” will be understood to exclude transitory signals but to include all forms of storage, including both volatile and non-volatile memories.

While the host device 500 is shown as including one of each described component, the various components may be duplicated in various embodiments. For example, the processor 520 may include multiple microprocessors that are configured to independently execute the methods described herein or are configured to perform steps or subroutines of the methods described herein such that the multiple processors cooperate to achieve the functionality described herein. Further, where the device 500 is implemented in a cloud computing system, the various hardware components may belong to separate physical systems. For example, the processor 520 may include a first processor in a first server and a second processor in a second server.

Various specific examples of models have been given herein, but other models may be used to carry out the identified functions. Also, various applications have been provided as example, but the embodiments described herein may be applied to almost any type of DIY video. The description of the indexing system described the use of manuals or other product information to assist in the indexing of the videos. Such materials assists in identifying tasks and the sub-tasks for each task. They also may provide important images and text data that may be used in training various models used by the DIY video system. For some videos, such manuals may not be available. In such a case, the DIY video indexer may user various image processing models, audio models, and language models to determine the various sub-tasks associated with a task portrayed in a DIY video. In many DIY videos without a related manual, enough information is available to segment the video into meaningful sub-tasks, and the DIY video system may still provide a useful capability to a user.

The DIY video system described herein helps solve the technological problem of finding specific DIY videos and the specific segments of the videos to assist a user in undertaking a DIY task such a repair. By finding such videos base upon a user query including a video or picture of the current state of the task and a question, the DIY video system can identify the specific video(s) needed to assist the user in completing the task. Further, the DIY video system may assist the user in determining whether a specific task has been proper completed. If so, the use may confidently move forward to the next task. If not, the user may seek to remedy the problem, before prematurely moving on to the next task. This allows for the user to better complete the DIY task without error. Further, it save the users a lot of time as compared to manually searching for videos related to a specific task until a relevant DIY video is found. Even, when such a relevant DIY vides is quickly found, often there may be additional sub-tasks portrayed in the video that are not relevant to the current task. The DIY video system assists the user in focusing in only the specific video segments that are relevant to the specific task at hand. All of these advantages provide a technological advantage and advancement of current methods and systems for using and present DIY videos.

The embodiments described herein may be implemented as software running on a processor with an associated memory and storage. The processor may be any hardware device capable of executing instructions stored in memory or storage or otherwise processing data. As such, the processor may include a microprocessor, field programmable gate array (FPGA), application-specific integrated circuit (ASIC), graphics processing units (GPU), specialized neural network processors, cloud computing systems, or other similar devices.

The memory may include various memories such as, for example L1, L2, or L3 cache or system memory. As such, the memory may include static random-access memory (SRAM), dynamic RAM (DRAM), flash memory, read only memory (ROM), or other similar memory devices.

The storage may include one or more machine-readable storage media such as read-only memory (ROM), random-access memory (RAM), magnetic disk storage media, optical storage media, flash-memory devices, or similar storage media. In various embodiments, the storage may store instructions for execution by the processor or data upon with the processor may operate. This software may implement the various embodiments described above.

Further such embodiments may be implemented on multiprocessor computer systems, distributed computer systems, and cloud computing systems. For example, the embodiments may be implemented as software on a server, a specific computer, on a cloud computing, or other computing platform.

Any combination of specific software running on a processor to implement the embodiments of the invention, constitute a specific dedicated machine.

As used herein, the term “non-transitory machine-readable storage medium” will be understood to exclude a transitory propagation signal but to include all forms of volatile and non-volatile memory.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method for presenting do-it-yourself (DIY) videos to a user related to a user task by a DIY video system, comprising:
receiving a user query including a first image file and a text question from a user regarding the current state of the user task;
extracting entities from the first image file to create entity data;
extracting question information from the text question;
extracting from a DIY video index a video segment related to the user task based upon the entity data and the question information; and
presenting the extracted video segment to the user.

2. The method of claim 1, further comprising:
receiving from the user a second image file corresponding to the state of the user task at completion of the user task; and
comparing the second image file to data indicating an ideal state at the completion of the user task.

3. The method of claim 2, further comprising indicating to the user that the user task is complete based upon the comparison of the second image file to data indicating an ideal state.

4. The method of claim 2, further comprising:
indicating to the user that the user task is not complete based upon the comparison of the second image file to data indicating an ideal state; and
providing to the user feedback as to the differences between the current state of the user task and the ideal state.

5. The method of claim 6, wherein providing to the user feedback includes displaying both the second image and an image of the ideal state to the user.

6. The method of claim 1, wherein the extracting from a DIY video index a video segment related to the user task based upon the entity data and the question information includes extracting a plurality of video segments, further comprising selecting a portion of the plurality of video segments to present to the user.

7. The method of claim 6, wherein the user task includes a plurality of sub-tasks and wherein the selected portion of the plurality of video segments corresponds to the sub-tasks.

8. The method of claim 6, wherein portions of the selected video segments are identified and combined together to present a contiguous video to the user.

9. The method of claim 1, wherein
user task includes a plurality of sub-tasks,
the user query indicates that the current state of the user task corresponds to a sub-task, and
presenting the extracted video segment to the user includes identifying a start point in the extracted video segment corresponding to the sub-task indicated by the current state of the user task.

10. The method of claim 1, wherein entity data includes identified objects identified in the first image file and the relative position of the identified objects to on another.

11. The method of claim 1, further comprising:
determining a tool or a part required to carry out the user task based upon the extracted video segment; and
providing to the user information where to acquire the tool or part and the cost of the tool or part.

12. The method of claim 11, further comprising:
receiving from the user information regarding an alternative source for acquiring the tool or part; and
adding the information regarding an alternative source for the tool or part to the DIY video index after the information has been approved by an expert.

13. A method for indexing do-it-yourself (DIY) videos that portray a user task in an index by a DIY video system, comprising:
receiving a DIY video;
applying a machine learning model to the received video to extract visual entity data from each frame in the DIY video and storing the visual entity data in the index;
extracting audio from the received video;
transcribing the extracted audio;
identifying user task segments in the transcribed audio;
determining temporal user task boundaries in the received video segment based upon the identified user task segments; and
storing user task segment data and the temporal user task boundaries in the index.

14. The method of claim 13, further comprising:
receiving manuals related to the received DIY video;
extracting meta data from the manual related to the user task; and
storing the extracted manual meta data in the index.

15. The method of claim 14, wherein the extracted meta data includes images related to the user task and text describing the steps of the user task.

16. The method of claim 13, wherein the visual entity data includes identifying objects in the frame and the relative position of the objects to one another in the frame.

17. The method of claim 13, wherein the visual entity data includes text found in the frame that is converted to a machine readable representation of the text.

18. The method of claim 13, further comprising extracting closed caption information from the received DIY video and storing the closed caption information in the index.

19. The method of claim 13, wherein the machine learning model is trained using data from a manual related to the task portrayed in the DIY video.

20. The method of claim 13, wherein the data stored in the index for the received video segment comprises a DIY video signature.

21. The method of claim 13, further comprising identifying sentence boundaries in the transcribed audio and storing sentence text from the transcribed audio in the index.

22. The method of claim 13, further comprising extracting text meta data associated with the received DIY video and storing the extracted text meta data in the index.
